(19) United States
(12) Patent Application Publication
(10) Pub. No.: US 2018/0011334 A1
(43) Pub. Date: Jan. 11, 2018

(54) Optical Arrangement for Spectral Decomposition of Light

(71) Applicant: Fraunhofer-Gesellschaft zur Förderung der angewandten Forschung e.V., Munchen (DE)

(72) Inventors: Uwe Detlef Zeitner, Weimar (DE); Thomas Flügel-Paul, Jena (DE); Dirk Michaelis, Jena (DE); Torsten Harzendorf, Jena (DE)

(21) Appl. No.: 15/644,527

(22) Filed: Jul. 7, 2017

(30) Foreign Application Priority Data
Jul. 7, 2016 (DE) 102016112504.0

(51) Int. Cl. G02B 27/42; G02B 5/18

(52) U.S. Cl. CPC G02B 27/4244; G02B 5/1814; G02B 5/1861

(57) ABSTRACT

An optical arrangement for spectral decomposition of light is disclosed. In an embodiment the optical arrangement includes a reflection diffraction grating, a first medium with a refractive index nᵢₙ arranged on a light incidence side of the reflection diffraction grating; and a second medium with a refractive index n_{G} arranged on a side of the reflection diffraction grating that faces away from the light incidence side, with nᵢₙ>n_{G}, wherein the optical arrangement is configured in such a way that light impinges on the reflection diffraction grating from the first medium at an angle of incidence α, wherein a condition sin(α)>n_{G}/nᵢₙ is satisfied, wherein the reflection diffraction grating comprises a layer system with at least one unstructured layer and at least one structured layer, wherein the at least one structured layer has a periodic structure with a period p in lateral direction, and wherein the period p meets the following conditions: p<λ/[nᵢₙ*sin(α)+n_{G}] and p>λ/[nᵢₙ*sin(α)+nᵢₙ].

### CROSS-REFERENCE TO RELATED APPLICATIONS

This application claims the benefit of German patent application 10 2016 112 504.0, filed on Jul. 7, 2016, which application is hereby incorporated herein by reference.

### TECHNICAL FIELD

The present application relates to an optical arrangement for the spectral decomposition of light, said optical arrangement containing a reflection diffraction grating.

### BACKGROUND

Use is often made of prisms or gratings for the spectral decomposition of light in various applications, such as, e.g., spectral analysis or the manipulation of laser pulses.

The fact that the refractive index n of the prism material depends on the wavelength λ of the incident light is often employed when using prisms. In accordance with the law of refraction,

n₀(λ)*sin(α₀)=n₁(λ)*sin(α₁) (E1),

different wavelengths are deflected to a different extent at the transition from a medium with a refractive index n₀ to a second medium with a refractive index n₁. Here, α₀ is the angle of incidence of the light at the interface and α₁ is the angle of the light that is refracted at the interface. Here, the angles are measured in relation to the normal direction of the interface in each case.

Should n₀>n₁ apply, the light at angles of incidence α₀>arcsin(n₁/n₀) is no longer able to pass through the interface (no real solution exists for α₁) and all of the light is reflected at the interface. This is referred to as total internal reflection.

If use is made of gratings, the spectral split is given by the grating equations:

Transmission: nᵢₙ*sin(α)−n_{G}*sin(β)=−m*λ/p (E2a)

Reflection: nᵢₙ*sin(α)−nᵢₙ*sin(β)=−m*λ/p (E2b)

Here, a denotes the angle of incidence on the grating in the medium with the refractive index nᵢₙ, β denotes the angle of the light that is diffracted at the grating in the medium with the refractive index n_{G} or nᵢₙ, m denotes an integer factor which denotes the order of diffraction and p denotes the grating period. Here too, the angles are measured relative to the direction of the normal of the grating surface in each case. Depending on the material properties in front of and behind the interface containing the grating, orders of diffraction in reflection and transmission arise at the grating. If angle of incidence α, refractive indices nᵢₙ and n_{G} and wavelength λ and grating period p are predetermined, the number of propagating orders of diffraction in reflection and transmission is given by the totality of all integer values m for which the equations (E2) supply real solutions for the diffraction angle β. This is satisfied for as long as |Re[sin(β)]|<=1, where Re denotes the real part of a complex number.

The achievable spectral split, or else dispersion, is given by the differential quotient dα₁/dλ for the prism and dβ/dλ for the grating. Typically, it is possible to obtain higher dispersions with gratings than with prisms since the dependence of the refractive index on the wavelength is limited for optically transparent materials. If the material dispersion is neglectable, the dispersion at the grating can be derived from the above-mentioned grating equation as

|dβ/dλ|=|m/[n_{B}*p*cos(β)]| (E3),

where n_{B}=n_{G} holds for transmission and n_{B}=nᵢₙ, holds for reflection.

Higher-order dispersions can advantageously be used to design the optical structure of, e.g., a spectrometer to be more compact. Therefore, many current arrangements use optical gratings as a dispersive element for the spectral decomposition of light. It is clear from equation (E3) that the dispersion increases as the ratio p/m (grating period to order of diffraction) decreases.

If use is made of diffraction gratings for the spectral decomposition of light, the applicable spectral range [λ₁ . . . λ₂] is defined by the application itself and it is generally restricted. λ₁ and λ₂ respectively denote the wavelengths at the short and long wavelength end, with Δλ=λ₂−λ₁ defining the so-called bandwidth. From the view of the application, it is particularly advantageous if light with a wavelength λ is diffracted as completely as possible into a single order of diffraction m during the spectral decomposition with a grating since light with different orders of diffraction (unequal to m) cannot be used for the desired application in many optical arrangements and therefore reduces the overall efficiency of the optical system. This is expressed by the diffraction efficiency nₘ of the m-th order of diffraction, which is expressed as

$${η}_{m}^{\frac{TE}{TM}} ( λ ) = {L}_{m}^{\frac{TE}{TM}} ( λ ) / {L}_{0} ( λ ) . \qquad ( E4 )$$

Here, L₀ is the light power that is incident on the grating and

$${L}_{m}^{\frac{TE}{TM}}$$

is the light power diffracted in the m-th order of diffraction. In general, the diffraction efficiency is dependent on the geometry of the grating and on both the wavelength and the polarization direction (TE or TM) of the incident light. TE and TM polarization denotes electrically linearly polarized light in this case, said light being polarized perpendicular or parallel to the plane of incidence. In general, the degree of polarization G is defined by the following relationship:

$$G ( λ ) = \vert \frac{{η}_{m}^{TE} - {η}_{m}^{TM}}{{η}_{m}^{TE} + {η}_{m}^{TM}} \vert \qquad ( E5 )$$

If G=0, this is referred to as polarization independence. The maximum value of G is 1 (100%). In respect of the obtainable diffraction efficiency ηₘ and the degree of polarization G, it should be noted that many spectroscopic applications require a vanishing degree of polarization and the highest possible mean diffraction efficiency [symbol] ηₘ [symbol] =(ηₘ^{TE}+ηₘ^{TM})/2.

Depending on application, a fundamental distinction is made between reflection gratings (incident light is reflected) and transmission gratings (incident light is transmitted through the grating) for describing the light path of the actual signal order or use order. Hence, transmission gratings rely on a transparent substrate material. In the case of reflection gratings, the required high degree of reflection is usually obtained by metallic layers and/or substrates. Moreover, use is also made here of dielectric layer systems, so-called Bragg layers, which are situated directly below the actual grating—on the side facing away from the light. For as long as the incident light is incident from air or a vacuum (nᵢₙ=1), there is no need to use optically transparent substrate materials in the case of reflection gratings. So-called immersion gratings, in which the incident light is incident not through air but through the substrate material with a refractive index nᵢₙ>n_{G}, represent a special case. In this case, an efficient reflection can also be obtained by total internal reflection. Here, the use of additional metallic layers and/or dielectric layer systems is not necessary for obtaining a high degree of reflection.

Independently of the distinction between reflection gratings and transmission gratings, similar geometries are used for both types in order to obtain a diffraction efficiency <ηₘ> (in reflection and transmission) that is as high as possible. A distinction is made between binary grating structures (p≦≈λ), which are usually operated in the ±1^{st} order and blazed gratings (p>λ), which have a linear variation in the grating structure elements. Here, so-called echelle gratings and echelette gratings represent special cases of blazed gratings. Although these are distinguished by a large ratio of grating period to wavelength p/λ, they are usually operated at very high orders of diffraction in order to obtain a high angle dispersion in accordance with equation (E3). Herein, the peculiarity consists of an efficient diffraction being obtained in a plurality of overlapping orders of diffraction.

In order to obtain a high efficiency of the light deflection in only one order of diffraction where possible, it is advantageous to restrict to the greatest possible extent the number of orders of diffraction that are able to propagate according to equation (E2). This can be achieved if the light is incident on the grating surface made of a material with a refractive index nᵢₙ, which is greater than the refractive index n_{G} of the material which is situated behind the grating in the homogeneous medium. This corresponds to the immersion gratings which were already mentioned above. Furthermore, if the angle of incidence α is selected for nᵢₙ>n_{G} according to

sin(α)>n_{G}/nᵢₙ (E6),

then there is no transmitting order of diffraction with m≧0 in the medium with n_{G}. Furthermore, the grating period is selected in such a way that

p<λ/[nᵢₙ*sin(α)+n_{G}] (E7)

applies, there also exist no further orders of diffraction with m<0 and α>0 in transmission, i.e., the light incident on the interface that is formed by the grating is completely reflected. In this case, the profile shape of the grating may be selected in such a way that the light is diffracted with a very high efficiency for at least one polarization direction into the reflected order of diffraction with m=−1. Here, this efficiency may lie close to 100%. In the case of the condition according to equation (E6), a grating with a very short grating period p<λ is obtained, and hence, according to equation (E3), a high dispersion.

The resultant nonlinearity of the dispersion is problematic for the application of highly dispersive gratings, as are described, e.g., by conditions (E5) and (E6). In the case of a given bandwidth Δλ of the spectrum to be decomposed, the nonlinearity of the dispersion over the spectrum increases with an increasing angle of diffraction. Initially, this is independent of the specific grating geometry. This is particularly problematic for the use in spectrometers since, in general, a uniform (equidistant) wavelength split over the spectral bandwidth is required on the detector in this case. The reason for this lies in the use of pixelated detectors with a uniform pixel grid. The nonlinearity leads to obtaining a significantly smaller distance between the wavelengths on adjacent detector pixels at the short wavelength end of the spectral range than at the long wavelength end of the spectrum. This nonlinearity of the dispersion is also referred to as an anamorphosis A and is given by the relationship of the dispersions at the two ends of the spectral range [λ₁ . . . λ₂] in accordance with

A=(dβ/dλ)λ₂/(dβ/dλ)λ₁ (E8).

For the eigenmodes propagating in the grating, the squares of the effective mode indices K₁=M₁*M₁ and K₂=M₂*M₂ can be estimated as follows:

$${K}_{1} = - {( \frac{λ}{2 p} )}^{2} + \frac{2}{p} {\int }_{- p / 2}^{+ p / 2} ɛ ( x ) {cos}^{2} ( \frac{π}{p} [ x - \tilde{x} ] ) dx \\ {K}_{2} = - {( \frac{λ}{2 p} )}^{2} + \frac{2}{p} {\int }_{- p / 2}^{+ p / 2} ɛ ( x ) {sin}^{2} ( \frac{π}{p} [ x - \tilde{x} ] ) dx , \qquad ( E9 )$$

where the center position \tilde{x} emerges at the minimum value of the magnitude of the sliding first moment

F(\tilde{x})=min_{y}[F(y)] with F(y)=|∫_{y-p/2}^{y+p/2}∈(x)(x−y)dx|.

In equation (E9), x is the coordinate in the grating plane perpendicular to the grating bars and ∈(x) is the dielectric constant of the grating material, correspondingly modulated by the period p, where ∈=n² applies.

In the case of simple binary gratings with one grating bar in the elementary cell, equation (E9) can be calculated explicitly and yields:

$${K}_{1} = - {( \frac{λ}{2 p} )}^{2} + [ {ɛ}_{trench} + f Δɛ + Δɛ \frac{sin ( π f )}{π} ] \\ {K}_{2} = - {( \frac{λ}{2 p} )}^{2} + [ {ɛ}_{trench} + f Δɛ - Δɛ \frac{sin ( π f )}{π} ] . \qquad ( E10 )$$

Here, Δ∈=∈_{trench}−∈_{bar} applies. ∈_{trench} and ∈_{bar} denote the dielectric constants of the trench material and bar material, respectively, where ∈=n² applies. The fill factor f is provided by the ratio of bar width w to grating period p, i.e., f=w/p.

In summary, immersion gratings which satisfy the conditions (E6) and (E7) are distinguished by, in particular, the following features: the gratings are realized directly in the substrate material which is distinguished by a typical refractive index of nᵢₙ<1.5. Accordingly, the bars of the grating consist of the corresponding substrate material and the trenches of the grating consist of air. Consequently, it is possible to derive that the difference of the squares of the effective mode indices ΔK of the two fundamental grating modes is restricted to a maximum value of ˜3/π (in the case of a fill factor of ½) (see equations (E9)). Consequently, the differences ΔM in the mode indices also hardly differ; this respectively applies for both polarization directions TE and TM. Consequently, high and polarization-independent diffraction efficiencies require very deep gratings. From a technological point of view, deep grating structures are also characterized by high aspect ratios, impairing the producibility. From a physical point of view, deep grating structures are also distinguished by a narrowband efficiency curve. The diffraction efficiency, to a first approximation, drops off again from the maximum value with a gradient that is proportional to the grating depth L.

Thus, in conclusion, it is possible to note that previous highly dispersive immersion gratings have deficiencies in relation to the polarization independence, spectral broad bandwidth property and production outlay.

### SUMMARY

Embodiments provide an optical arrangement for the spectral decomposition of light which realizes a high angle dispersion and has a very high and polarization-independent diffraction efficiency.

Further embodiments provide an optical arrangement for the spectral decomposition of light with wavelengths λ in a spectral range λ₁≦λ≦λ₂. The spectral range [λ₁ . . . λ₂] can, depending on the field of application of the optical arrangement, comprise, e.g., wavelengths in the visible spectral range, in the UV range and/or in the IR range.

In accordance with at least one embodiment, the optical arrangement comprises a reflection diffraction grating, wherein a first medium with a refractive index nᵢₙ, is arranged on a light incidence side of the reflection diffraction grating and a second medium with a refractive index n_{G} is arranged on a side of the reflection diffraction grating that faces away from the light incidence side, with nᵢₙ>n_{G}. The first medium with the refractive index nᵢₙ is preferably a transparent solid, for example, a substrate or an optical element, onto which the reflection diffraction grating has been applied. In a preferred configuration, the reflection grating is applied to a prism. In this case, the first medium is the material of the prism, for example, a glass. The second medium on a side that faces away from the light incidence side is preferably the ambient medium such as, e.g., air or a vacuum. In this case, n_{G} is approximately 1.

The optical arrangement is preferably constructed in such a way that light impinges on the reflection diffraction grating from the first medium at an angle of incidence α, wherein the condition sin(α)>n_{G}/nᵢₙ is satisfied.

Advantageously, the reflection diffraction grating comprises a layer system with at least one unstructured layer and at least one structured layer, wherein the at least one structured layer has a periodic structure with a period p in the lateral direction, and wherein the period p first of all meets the following condition:

p<λ/[nᵢₙ*sin(α)+n_{G}]. In this case, there is advantageously no order of diffraction in transmission. Further, the period p satisfies the condition

p>λ/[nᵢₙ*sin(α)+nᵢₙ]. (E11)

In this case, only the 0^{th} and −1^{st} order of diffraction in reflection occur. The reflection diffraction grating with these properties is distinguished, in particular, by a high diffraction efficiency.

It is possible for the reflection diffraction grating to have a plurality of structured layers which need not necessarily have the same period p. By way of example, if the reflection diffraction grating has a plurality of periodic structures with periods pⱼ, where j is a layer index, the aforementioned conditions must be satisfied for the period of at least one of the periods pⱼ.

In accordance with an advantageous configuration, the at least one structured layer which has the period p is arranged on the side of the reflection diffraction grating that faces away from the light incidence side.

In a configuration, the reflection diffraction grating can comprise a plurality of structured layers. In this case, all structured layers are preferably arranged on the side that faces away from the light incidence side. Advantageously, in this case, no unstructured layer is arranged between any of the structured layers and the side that faces away from the light incidence side.

In a preferred configuration, at least one of the following three conditions a), b) or c) is satisfied for the squares of the effective mode indices K₁=M₁*M₁ and K₂=M₂*M₂ (see equations (E9)) for the at least one structured layer:

K₁≦0 and K₂>0 a)

K₂≦0 and K₁>0 b)

K₂≦0 and K₁≦0 c)

It was found that solutions with a low grating depth and a high bandwidth of the diffraction efficiency could be found if the variables K₁=M₁*M₁ and K₂=M₂*M₂ (see equations (E9)) of the eigenmodes propagating in the grating have different signs, i.e., K₁<0 and K₂>0 applies, or vice versa. Moreover, the eigenmode with a positive K-value should preferably have a large magnitude.

In accordance with an advantageous configuration, the reflection diffraction grating consists of two layers, of which one layer is structured and the other layer is unstructured. In this case, the unstructured layer is advantageously arranged on the light incidence side and the structured layer is arranged on the side that faces away from the light incidence side.

Preferably, the unstructured layer has a refractive index n₂ which satisfies the following conditions:

$$\vert \frac{{n}_{2}^{2} \sqrt{{n}_{in}^{2} - {n}_{in}^{2} sin α} - {n}_{in}^{2} \sqrt{{n}_{2}^{2} - {n}_{in}^{2} sin α}}{{n}_{2}^{2} \sqrt{{n}_{in}^{2} - {n}_{in}^{2} sin α} + {n}_{in}^{2} \sqrt{{n}_{2}^{2} - {n}_{in}^{2} sin α}} \vert < 0.05 and$$

$$\vert \frac{\sqrt{{n}_{in}^{2} - {n}_{in}^{2} sin α} - \sqrt{{n}_{2}^{2} - {n}_{in}^{2} sin α}}{\sqrt{{n}_{in}^{2} - {n}_{in}^{2} sin α} + \sqrt{{n}_{2}^{2} - {n}_{in}^{2} sin α}} \vert > 0.05 .$$

The structured layer preferably has a periodic grating profile having two levels. Expressed differently, the structured layer has a binary height profile. In particular, the periodic structure of the structured layer can comprise grating bars with a refractive index nₛ and grating trenches, with the grating trenches containing air or a vacuum. The surfaces of the grating bars and the base areas of the grating trenches in this case form the two levels of the grating profile. Particularly preferably, the grating bars and the unstructured layer are formed from the same material with a refractive index n₂=nₛ>nᵢₙ.

In a preferred configuration, the optical arrangement comprises a prism, wherein the reflection diffraction grating is arranged at or on the prism. In this case, the first medium, i.e., the medium at the light incidence side of the reflection diffraction grating is formed by the prism.

In accordance with at least one configuration, the prism comprises a first surface, a second surface and a third surface, wherein the first surface of the prism is provided as a light input surface. The second surface of the prism is provided for reflecting incident light to the third surface, wherein the reflection diffraction grating for the spectral decomposition of the incident light is arranged on the third surface. Moreover, the second surface of the prism serves as a light output surface of the light that is reflected and spectrally decomposed by the reflection diffraction grating.

In a preferred embodiment, the light is incident on the second surface of the prism at an angle (W) which is greater than the critical angle of the total internal reflection. Furthermore, it is advantageous if the angle of incidence α at which the light impinges on the third surface is greater than the critical angle of the total internal reflection.

In a preferred configuration, the grating bars of the reflection diffraction grating are coated by a material which has a refractive index n_{H} that is greater than the refractive index nᵢₙ of the prism. Preferably, the refractive index is n_{H}>2.0. In a further preferred configuration, the grating bars of the reflection diffraction grating have a refractive index nₛ that is greater than the refractive index nᵢₙ, of the prism. Preferably, nₛ>2.0.

A particularly high diffraction efficiency is obtained by the high refractive index of the grating bars or of the material with which the grating bars are coated. In particular, this allows the difference of the squares of the mode indices ΔK to be significantly increased. If use is made of a material with a refractive index of, e.g., nₛ=2.0 (instead of, e.g., n=1.5) as the bar material of the grating, the maximum value of ΔK can be increased to ˜6/π. Without any further measures, this leads to a significant reduction in the necessary grating depth, provided that TE polarization and TM polarization are considered separately. Furthermore, the spectral bandwidth also advantageously increases.

In accordance with a preferred embodiment, the prism has a refractive index nᵢₙ<1.6. In particular, the prism may comprise fused silica.

### BRIEF DESCRIPTION OF THE DRAWINGS

Below, the invention will be explained in more detail on the basis of exemplary embodiments in conjunction with the FIGS. 1 to 12.

FIGS. 1 and 2 show a schematic illustration of an exemplary embodiment of an optical arrangement for the spectral decomposition of light;

FIGS. 3A and 3B show a schematic illustration of two examples of an optical arrangement for the spectral decomposition of light and the polarization-dependent diffraction efficiencies depending on the wavelength;

FIGS. 4 and 5 each show a schematic illustration of an exemplary embodiment of an optical arrangement for the spectral decomposition of light, comprising a prism; and

FIGS. 6 to 12 each show schematic illustrations of further examples of the optical arrangement for the spectral decomposition of light.

In the figures, the same elements or elements with the same effect are represented by the same reference sign. The depicted components and the size ratios of the components amongst themselves should not be considered to be true to scale.

### DETAILED DESCRIPTION OF ILLUSTRATIVE EMBODIMENTS

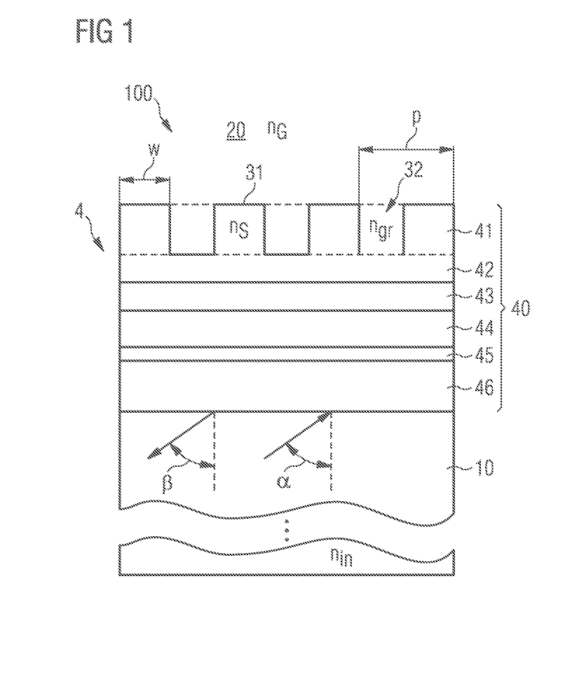

The exemplary embodiment of an optical arrangement 100 for the spectral decomposition of light presented in FIG. 1 comprises a reflection diffraction grating 4 which is formed by a layer system 40. In the example shown here, the layer system 40 comprises a structured layer 41 and a plurality of unstructured layers 42, 43, 44, 45, 46. The layer system 40 may comprise layers made of different materials, wherein the individual layers may have different refractive indices. In the lateral direction, the structured layer 41 has a periodic structure with a period p. In the example presented here, the periodic structure is a grating structure which is formed by grating bars 31 with a bar width w and grating trenches 32 arranged there between. The ratio between bar width w and the grating period p is referred to as fill factor f=w/p.

A first medium 10 with a refractive index nᵢₙ, is arranged on the light incidence side of the reflection diffraction grating 4. By way of example, the first medium 10 can be the material of a transparent substrate, on which the reflection diffraction grating 4 is arranged. A second medium 20 with a refractive index n_{G}, where nᵢₙ>n_{G}, is arranged on a side that faces away from the light incidence side of the reflection diffraction grating 4. In particular, the second medium 20 can be the ambient medium such as, e.g., air or a vacuum. In the example presented here, the grating structure formed by the grating bars 31 directly adjoins the ambient medium, e.g., air or a vacuum. Hence, the grating trenches 32 of the grating likewise contain air or a vacuum with a refractive index n_{gr}≈1.

The light impinges on the reflection diffraction grating 4 from the first medium 10 at an angle of incidence α. In order to minimize the number of propagating orders of diffraction, and hence the number of possible loss channels, a configuration of angles of incidence, refractive indices and grating periods which simultaneously satisfies the conditions (E6) and (E7) is selected. All the light can be reflected without the use of reflecting layers or materials by virtue of the effect of total internal reflection. In accordance with (E6), the angle of incidence must lie between the angle of total internal reflection and 90°. In the case of nᵢₙ=1.45 and n_{G}=1.0, this means, e.g., 44°<α<90°.

Furthermore, the angle of incidence α is advantageously selected in such a way that the Littrow condition nᵢₙ sin(α)≈λ/(2p) is approximately satisfied. Here, X denotes any wavelength in the spectral range [λ₁ . . . λ₂]. If this condition, which is also referred to as the Littrow configuration, is satisfied, it is advantageously possible to obtain a high diffraction efficiency. If the reflected light should be spatially separated from the incident light, the Littrow condition should not be satisfied exactly but only approximately since incident and diffracted (reflected) beams overlap.

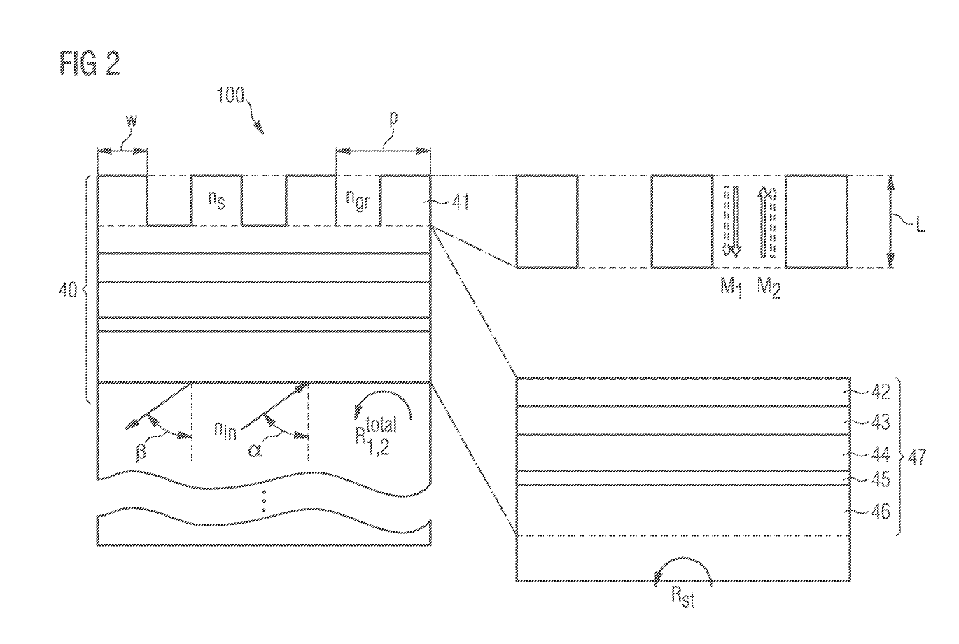

FIG. 2 once again shows the optical arrangement 100 in accordance with FIG. 1, with the components of the reflection diffraction grating 4 being presented in more detail by way of an exploded illustration. The two fundamental eigenmodes of the grating, characterized by their effective mode indices M1 and M2, and the corresponding mode reflectivities R1, R2 are indicated schematically.

Essentially, only two relevant orders of diffraction (m=0 and m=−1) occur in the first medium with the refractive index nᵢₙ and the unstructured grating layers 42, 43, 44, 45, 46. Propagating in the structured layer 41 there mainly (but not exclusively) are two grating normal modes. In the frequent case of mirror symmetrical refractive index distributions within the elementary cell of the grating layers, these two main modes have a strict symmetric and anti-symmetric form. This applies both to the case of TE polarization and to the case of TM polarization.

A high diffraction efficiency in the −1^{st} order of diffraction in the TM polarization can be achieved by virtue of the two existing TM eigenmodes M₁ and M₂ of the grating experiencing a phase shift of (2*N+1)π after a complete circulation in the grating layer system (40), i.e., if

arg(R₁^{total,TM})≈arg(R₂^{total,TM})+(2N+1)π.

On account of the fact that the grating only has two channels in the specified configuration (namely the 0^{th} and the −1^{st} order of diffraction in reflection), diffraction efficiencies of virtually 100% can be reached under the Littrow condition. Normally, the mode reflection coefficients R_{1,2} are calculated with the aid of numerical methods (e.g., RCWA). As a result, the ideal geometry parameters of the grating then are available (in the case of a binary grating with grating bars, these are f=w/p and the grating depth L), and so the diffraction efficiency for the TM polarization is maximized for the −1^{st} order of diffraction η₋₁^{TM}. In general, the diffraction efficiency for the TE polarization η₋₁^{(TE)} for the grating geometry thus ascertained will, however, be significantly smaller, i.e., not ideal.

When designing the optical arrangement, a layer stack 47 which may comprise one or more dielectric layers 42, 43, 44, 45, 46 is added, preferably directly under the structured layer 41, after the grating structure of the structured layer 41 has been set. The layer stack 47 has reflectivities Rₛₜ^{TM}(λ) and Rₛₜ^{TM}(λ), which are preferably optimized in such a way that the following applies for incidence of light with the wavelength λ, with λ₁≦λ≦λ₂, and having the angle of incidence α: |Rₛₜ^{TM}|≈0 and Rₛₜ^{TE}≧0.

Thus, the layer stack 47 acts as an anti-reflection layer system, which only works with TM polarization and still has non-vanishing reflectivities for TE polarization. The simplest system able to meet this condition is a single dielectric layer with a refractive index as per nₛₜ=nᵢₙ tan(α), because the angle of incidence α then simultaneously corresponds to the Brewster angle between the materials nᵢₙ and nₛₜ.

As a consequence, the layer stack 47 has no optical function for TM polarization as the reflectivities R_{1/2}^{total,TM} of the TM eigenmodes of the grating remain unchanged. The previously obtained diffraction efficiency of the grating is therefore (virtually) maintained in the TM polarization. However, at the same time, the layer stack 47 must have a non-vanishing and also adjustable reflectivity Rₛₜ^{TE}(λ, α) in the TE polarization. Using this, it is possible to detune the reflectivities R_{1/2}^{total,TE} of the TE eigenmodes and, by optimizing the layer stack 47, it is now also possible to obtain the optimal efficiency for the TE polarization under otherwise unchanging grating geometry and bring this into correspondence with the ideal in the TM polarization.

Preferred solutions with a low grating depth and high bandwidth of the diffraction efficiency can be found if the variables K₁=M₁*M₁ and K₂=M₂*M₂ (see equations (E9)) of the eigenmodes propagating in the grating have different signs, i.e., if K₁<0 and K₂>0, or vice versa, applies. The phase offset between the two eigenmodes is the greatest under these conditions.

The use of highly refractive materials in structured layers increases the difference between K₁ and K₂, or M₁ and M₂, which, according to equations (E9), in turn leads to smaller grating depths L and hence more broadband solutions.

The optical arrangement 100 described herein has, in particular, the following advantages:

i) Very high diffraction efficiencies of close to 100% can be obtained simultaneously for TE polarization and TM polarization.

ii) The optical performance in the TE polarization can be influenced and optimized in a targeted manner without decisively changing the efficiency for the TM polarization by way of the targeted insertion of a dielectric AR layer system 47, which only effects the TE polarization and has little effect on the TM polarization. This procedure is helpful when searching for grating structures with a polarization-independent performance.

iii) Moderate grating depths L, which lead to a corresponding broad bandwidth of the grating performance, are achievable by using adapted layer systems 47 and/or highly refractive grating materials.

iv) This realizes an optical arrangement 100 for the spectral decomposition of light which is simultaneously distinguished by a high diffraction efficiency, a polarization independence, a broad bandwidth and a high angle dispersion.

v) It is possible to obtain small aspect ratios, which have an expedient effect on the producibility.

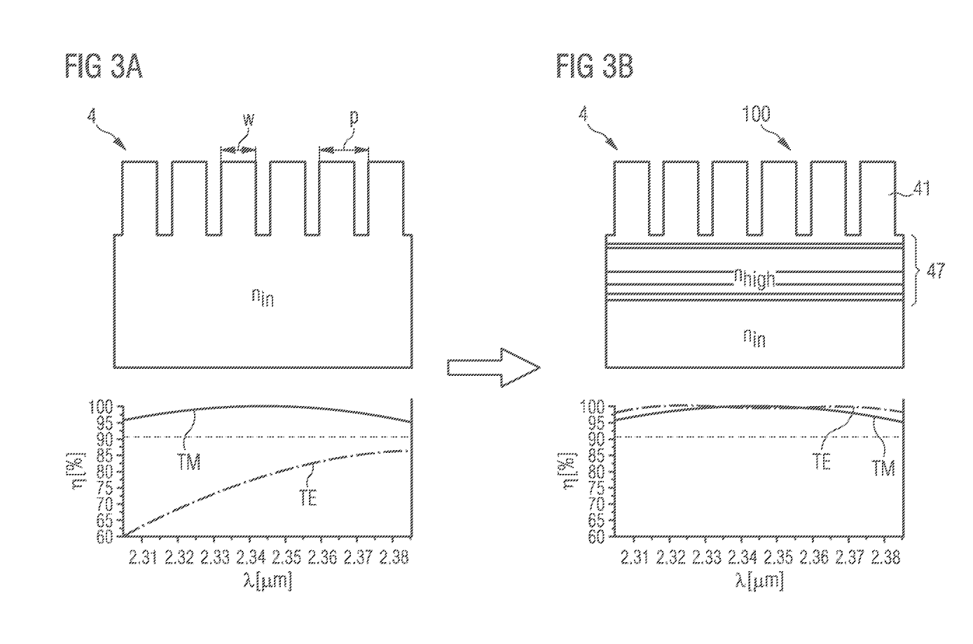

By way of example, the procedure sketched above in respect of designing the optical arrangement for the spectral decomposition of light can be understood on the basis of the example presented in FIGS. 3A and 3B.

In the first step, the diffraction efficiency of the reflection diffraction grating 4 is only optimized for TM polarization. In general, this is carried out with the aid of numerical methods. FIG. 3A shows the reflection diffraction grating and the diffraction efficiency for the TE polarization and the TM polarization. In this example, diffraction efficiencies of greater than 95% are obtained for the TM polarization in the relevant spectral range. However, the diffraction efficiency for the TE polarization lies far below 90%.

The diffraction efficiency for the TE polarization can likewise be influenced in a decisive manner, without influencing the efficiency for the TM polarization, by way of the insertion, presented in FIG. 3B, of a layer stack 47 below the unmodified grating and by the subsequent optimization of the layer thicknesses of each individual layer of the layer stack 47. As a result, a grating is obtained with a very high diffraction efficiency and a degree of polarization of less than 2% in the specified example.

By way of example, the following data for the optical arrangement 100 emerge from the optimization:

Wavelength range: Δλ=2305 nm-2385 nm
Substrate material: Fused silica, nᵢₙ=1.45
Material outside of the grating: Air, n_{G}=1.0
Material of the grating bar: Fused silica, nₛ=1.45
Fill factor: f=0.55
Material of the highly refractive layers of Titanium dioxide, n=2.35
the layer stack:
Angle of incidence α on the grating: 61°
Grating period p: 935 nm

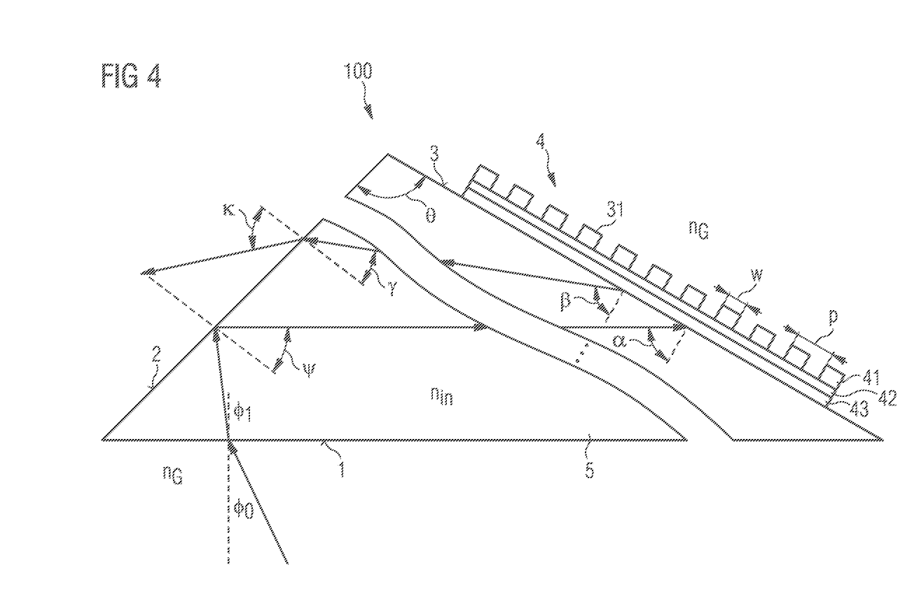

A particularly advantageous optical arrangement 100 in accordance with the proposed principle is presented in FIG. 4. Here, this is a dispersive component which not only realizes a high dispersion but also has a polarization-independent, very high diffraction efficiency and a very small nonlinearity of the dispersion (A≈1).

In particular, these goals can be achieved by a combination of the reflection diffraction grating 4 with a prism 5. The configuration of the reflection diffraction grating 4 preferably corresponds to one of the above-described exemplary embodiments. When the reflection diffraction grating 4 is arranged on a prism, the material of the prism 5 is the same as that of the above-described first medium on the light incidence side of the reflection diffraction grating 4.

The prism 5 contains three optically effective surfaces 1, 2, 3. Initially, the light passes from the surrounding medium with a refractive index n_{G} into the prism 5 with a refractive index nᵢₙ, at an angle Φ₀ through the first surface 1 and said light is refracted at the first surface 1 in accordance with equation (E1). The second surface 2 of the prism 5 is arranged in relation to the first surface 1 in such a way that the incident light undergoes total internal reflection at an angle Ψ>arcsin(n_{G}/nᵢₙ) on the second surface 2 and said light is deflected in the direction of the third surface 3. The reflection diffraction grating 4, which satisfies the condition given by equations (E7, E11), is arranged on the third surface 3. Here, the orientation of the third surface 3 is selected in such a way that the condition of equation (E6) is satisfied for the angle of incidence α of the light on the third surface 3. This ensures that, in accordance with equation (E2), only the two orders of diffraction with the orders m=0 and m=−1 can occur in reflection at the reflection diffraction grating 4. The order m=0 (not plotted in FIG. 4) is not considered again below as it cannot be used for spectral splitting of the light. The direction of propagation thereof is independent of the light wavelength in accordance with equation (E2). In FIG. 4, this order of diffraction would, in accordance with the law of reflection, be reflected at the third surface 3 and deflected to the first surface 1.

The periodic structure of the reflection diffraction grating 4 is designed in such a way that light that is incident on the grating is reflected with as little polarization dependence as possible into the m=−1 order of diffraction with a high efficiency. The different spectral components of the incident light are diffracted in different directions β(λ) in accordance with equation (E2). The arrangement is designed in such a way that all wavelengths in the relevant spectral range Δλ propagate back in the direction of the second surface 2. Said wavelengths are incident on this surface at the angle γ, for which sin(γ)<n_{G}/nᵢₙ applies, and so no total internal reflection occurs; instead, the light can pass through the second surface 2 and said light is refracted in the process in accordance with the law of refraction (E1). What is achieved by combining the diffraction at the reflection diffraction grating 4 on the third surface 3 with the refraction of the light upon emergence from the prism 5 through the second surface 2 is that the nonlinearity of the dispersion of the entire optical arrangement 100 is minimized and, hence, an anamorphosis of A≈1 is achievable over the entire spectral range Δλ.

A high polarization-independent diffraction efficiency for the m=−1 order of diffraction in reflection can be obtained with a reflection diffraction grating 4 in accordance with the configurations described above. In order to maximize the overall transmission of the optical arrangement 100, an antireflection coating that is matched to the wavelength range Δλ and the respective angle of incidence range can be applied onto the first surface 1 and/or onto the second surface 2 (not presented here).

The grating bars 31 of the reflection diffraction grating 4 preferably have a refractive index nₛ which is greater than the refractive index nᵢₙ of the prism 5. In particular, the refractive index nₛ of the grating bars can be nₛ>2 and the refractive index of the prism can be nᵢₙ<1.6. Alternatively, or additionally, the grating bars 31 of the reflection diffraction grating 4 may be coated by a material which has a refractive index n_{H} that is greater than the refractive index nᵢₙ of the prism 5. In this case, preferably, n_{H}>2.

The optical arrangement 100 in which the reflection diffraction grating 4 is arranged on the prism 5 has, in particular, the following advantages: the angle of incidence of the light Φ₀ on the first surface 1 of the prism 5 is decoupled from the angle of incidence α on the grating 4. In particular, the angle of incidence t on the first surface 1 can be designed in such a way that it lies virtually in the direction of the normal thereof, as a result of which a high polarization-independent transmission is achievable. Also, simple antireflection layers can be realized for a virtually perpendicular incidence. By selecting the direction of incidence on the third surface 3 that has been structured with the grating 4 in accordance with the condition (E6) and by selecting the grating period p in accordance with condition (E7, E11), it is possible to achieve a very high diffraction efficiency in only one reflected order of diffraction. Here, the use of an optical material for the prism 5 with a refractive index that is not too high is advantageous. Preferably, nᵢₙ<1.6 should apply for said material. In particular, fused silica is a suitable material for the prism 5.

As a result of the additional refraction of the light on the second surface 2 that acts as an emergence surface, there is a significant reduction in the nonlinearity of the dispersion and it is possible to achieve values for the anamorphosis of the entire optical arrangement of A≈1.

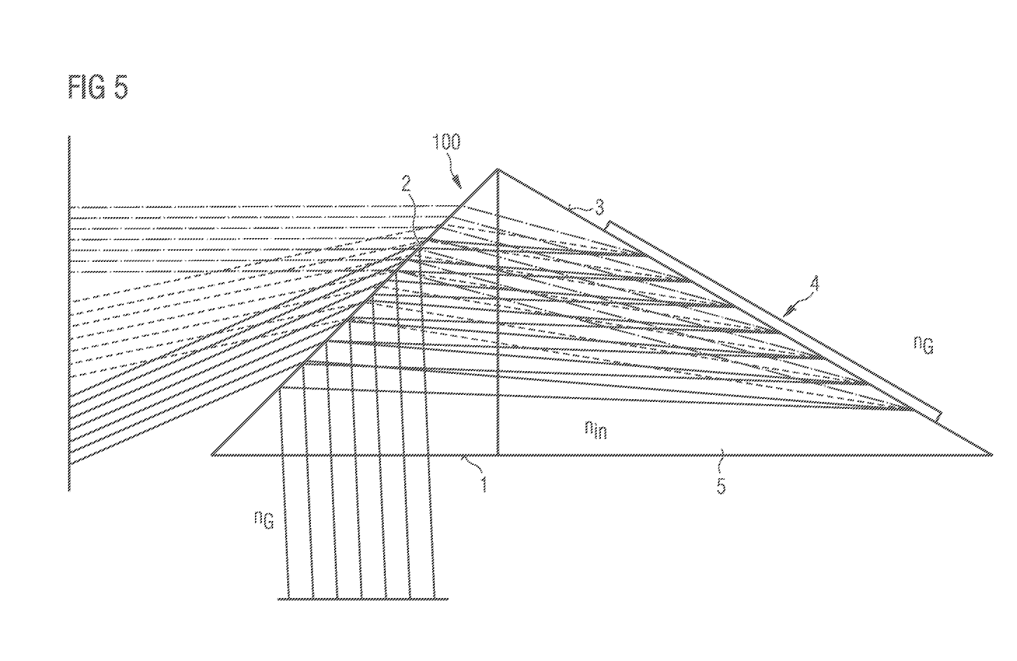

The beam path in an optical arrangement 100 with the prism 5 and the reflection diffraction grating 4 is presented for an exemplary embodiment in FIG. 5. In particular, the optical arrangement 100 may have the following parameters:

Wavelength range: Δλ=2305 nm-2385 nm
Prism material: Fused silica, nᵢₙ=1.45
Material outside of the prism: Air, n_{G}=1.0
Angle of incidence on the first surface: 7.2°
Angle of incidence on the grating: 54°
Grating period: p=935 nm
Angle between surface 1 and surface 2: 46°
Angle between surface 2 and surface 3: 105°

Using these parameters, an overall dispersion of 18° is realized over the aforementioned spectral range. Here, the anamorphosis is A=1.1.

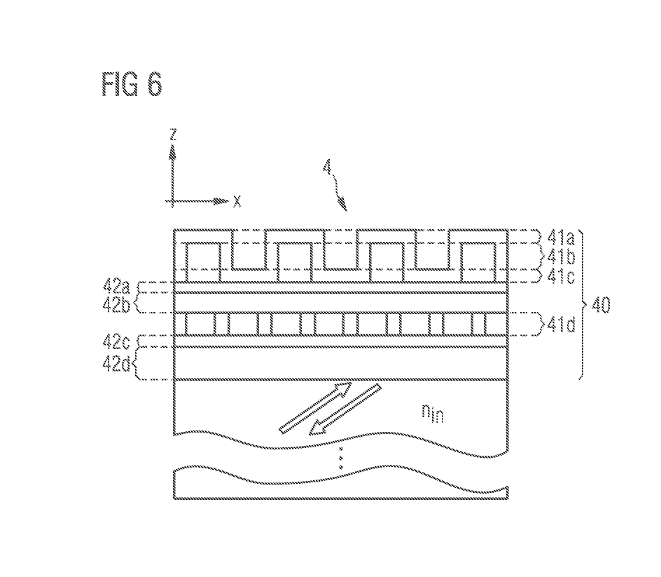

FIGS. 6 to 12 below show further possible configurations of the reflection diffraction grating. In particular, these configurations can be combined with the arrangement of the reflection diffraction grating on a prism, as shown in FIGS. 4 and 5.

FIG. 6 schematically shows a reflection diffraction grating 4 which has a layer system 40 made of structured layers 41a, 41b, 41c, 41d and unstructured layers 42a, 42b, 42c, 42d. In general, the layer system 40 can be composed from any number of structured and unstructured layers. A region in which the refractive index n(x) (x denotes the coordinate axis along the layers) is independent of the z-coordinate (z denotes the coordinate axis perpendicular to the layers) is referred to as a layer.

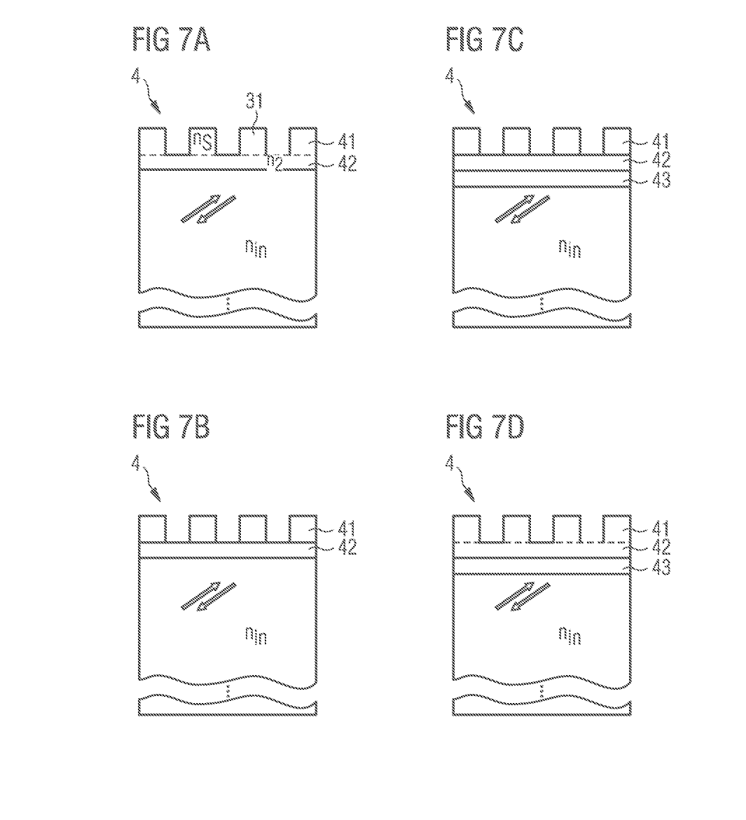

FIGS. 7A to 7D schematically show four examples of reflection diffraction gratings 4 which each have a binary grating structure, i.e., a grating structure which only has two levels. In particular, the binary grating structure can be a structure made of alternating grating bars and grating trenches, the height profile of which corresponds to a periodic rectangular function. In the examples presented here, the material in the grating trenches in each case corresponds to the ambient material on the side that faces away from the light.

In the examples of the FIGS. 7A and 7B, the reflection diffraction grating 4 in each case has exactly two layers, namely a structured layer 41 and an unstructured layer 42. The unstructured layer 42 is arranged on the light incidence side and the structured layer 41 is arranged on the side that faces away from the light. In the example of FIG. 7A, the grating bars 31 and the unstructured layer 42 advantageously have the same material in each case. In particular, the unstructured layer 42 can have a refractive index n₂ which equals the refractive index nₛ of the grating bars 31. Particularly preferably, the grating bars 31 and the unstructured layer 42 each have a highly refractive material with a refractive index >2, such that n₂>2 and nₛ>2 apply.

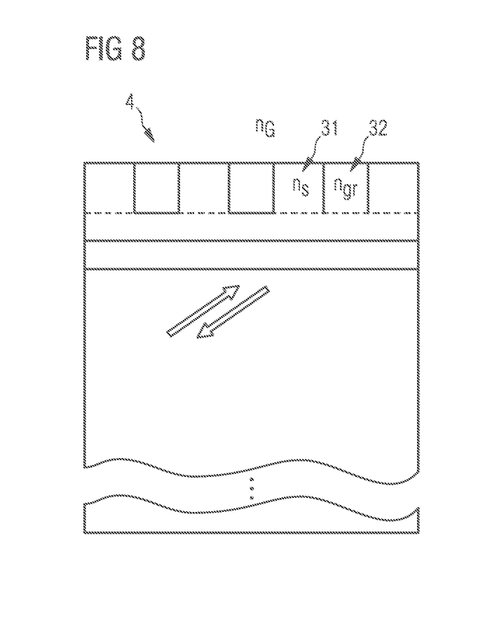

FIG. 8 schematically shows a reflection diffraction grating 4 which has a so-called filled binary grating structure. In this configuration, a material which does not correspond to the ambient material on the side that faces away from the light is arranged in the grating trenches 32. The material in the grating trenches 32 may have a refractive index n_{gr} which does not equal the refractive index n_{G} of the ambient material and does not equal the refractive index nₛ of the grating bars 31.

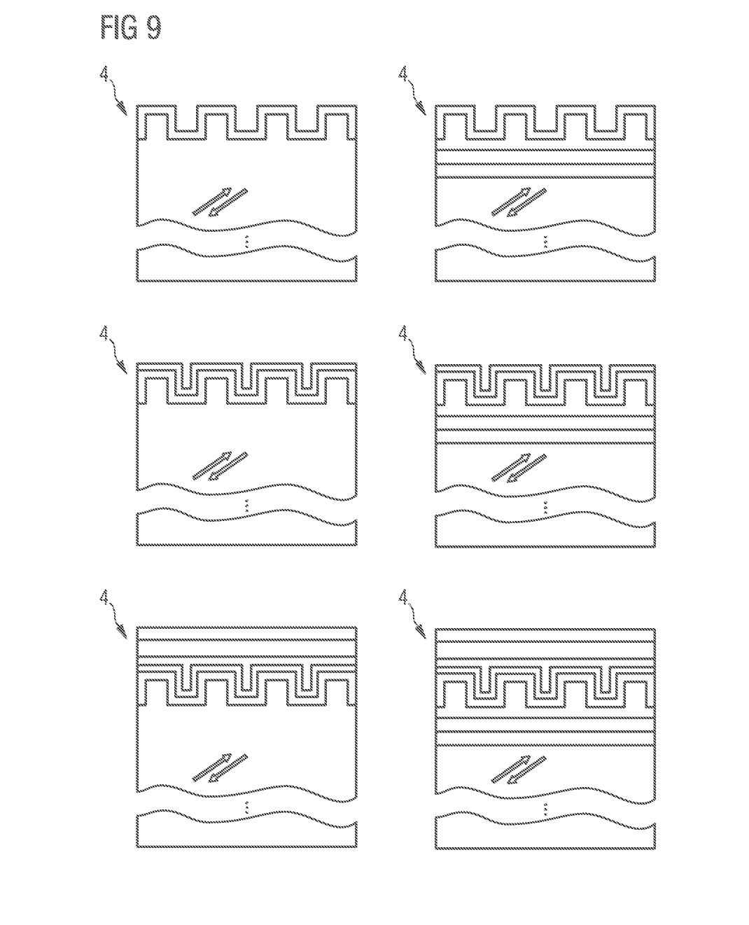

FIG. 9 schematically shows a plurality of examples of reflection diffraction gratings 4 which have binary grating structures that have been covered. The grating structure may be covered by one or more layers. Here, the at least one layer can conformally cover the grating structure or fill the grating trenches. The grating structure is preferably covered by a material which has a refractive index n_{H} that is greater than the refractive index nᵢₙ of the first medium, for example, of a prism. In this case, preferably n_{H}>2.

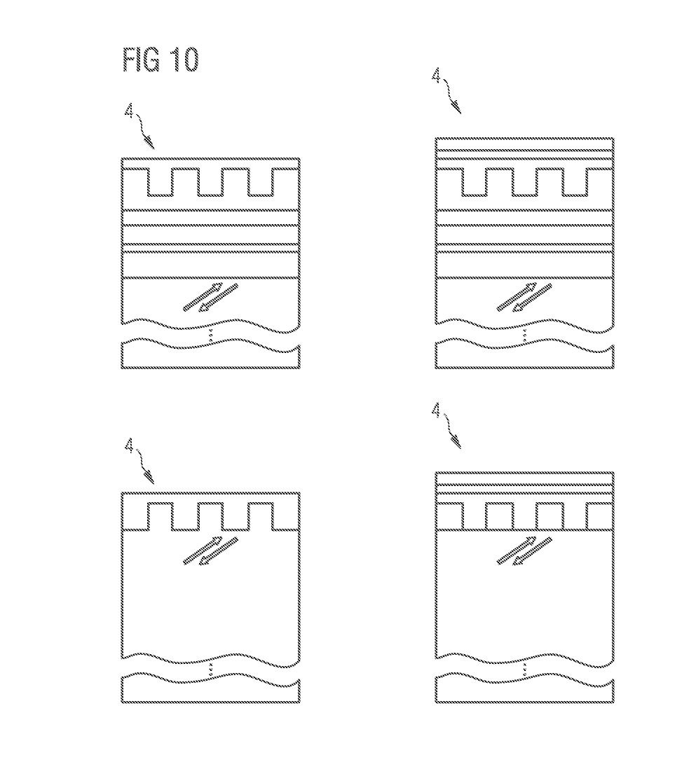

FIG. 10 schematically shows four different examples of reflection diffraction gratings 4 which have filled grating structures. Presented are various configurations in which at least one unstructured layer or a layer stack made of unstructured layers are arranged below the structured layer, i.e., on the light incidence side, above the structured layer or on both sides of the structured layer.

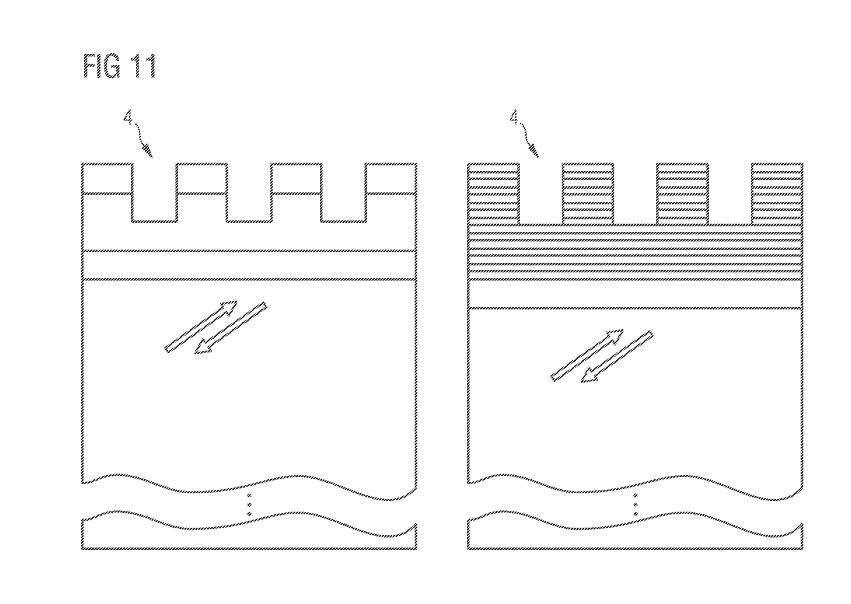

FIG. 11 schematically shows two examples of reflection diffraction gratings 4 which have binary multi-layered grating structures. In these examples, the grating structure in a layer stack is made of at least two or more layers.

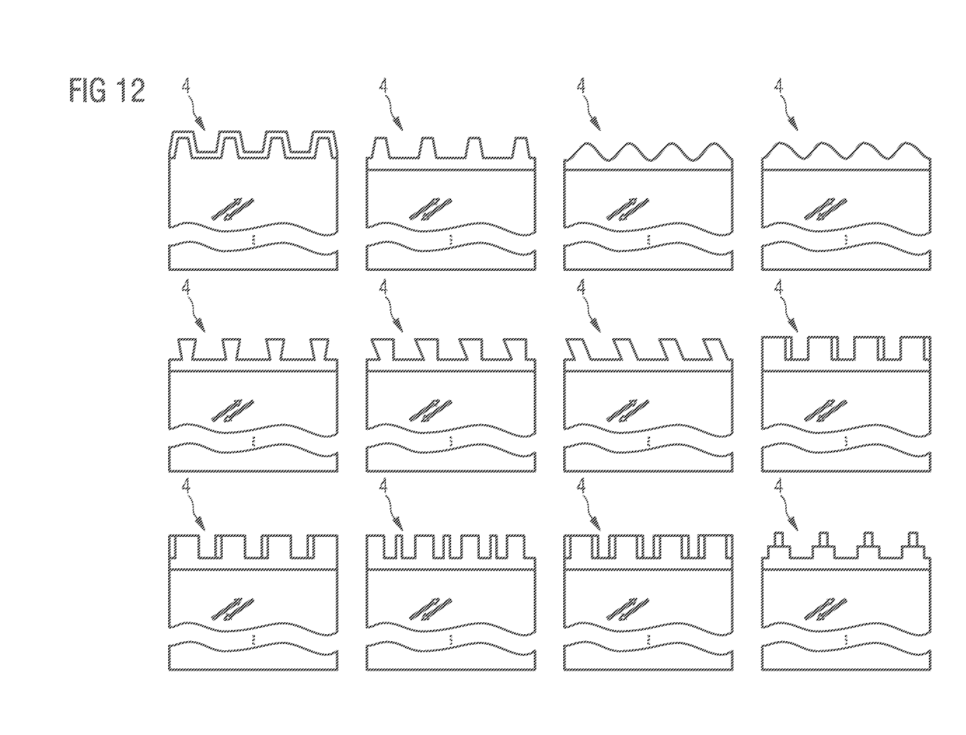

FIG. 12 schematically shows a plurality of the further examples of reflection diffraction gratings 4 which have various possible geometries. In these examples, the grating structure deviates from binary grating structures and/or the grating structure is formed from various materials. The grating geometries presented in FIG. 12 are also combinable with the layers presented above in FIGS. 1 and 7 to 11 or with layer stacks made of unstructured layers.

The invention is not restricted by the description on the basis of exemplary embodiments. Rather, the invention comprises every novel feature and every combination of features, which, in particular, contains every combination of features in the patent claims, even if this feature or this combination itself has not been explicitly specified in the patent claims or in the exemplary embodiments.

What is claimed is:

1. An optical arrangement for a spectral decomposition of light with wavelengths λ in a spectral range λ₁≦λ≦λ₂, the optical arrangement comprising:
a reflection diffraction grating;
a first medium with a refractive index nᵢₙ arranged on a light incidence side of the reflection diffraction grating; and
a second medium with a refractive index n_{G} arranged on a side of the reflection diffraction grating that faces away from the light incidence side, with nᵢₙ>n_{G},
wherein the optical arrangement is configured in such a way that light impinges on the reflection diffraction grating from the first medium at an angle of incidence α,
wherein a condition sin(α)>n_{G}/nᵢₙ is satisfied,
wherein the reflection diffraction grating comprises a layer system with at least one unstructured layer and at least one structured layer,
wherein the at least one structured layer has a periodic structure with a period p in lateral direction, and
wherein the period p meets the following conditions:
p<λ/[nᵢₙ*sin(α)+n_{G}] and
p>λ/[nᵢₙ*sin(α)+nᵢₙ].

2. The optical arrangement according to claim 1, wherein the at least one structured layer has the period p arranged on a side of the reflection diffraction grating that faces away from the light incidence side.

3. The optical arrangement according to claim 1, wherein the reflection diffraction grating comprises a plurality of structured layers, and wherein all structured layers are arranged on a side that faces away from the light incidence side.

4. The optical arrangement according to claim 1, wherein one of the following three conditions is satisfied for squares of effective mode indices K₁, K₂ in the at least one structured layer:
K₁≦0 and K₂>0, or
K₂≦0 and K₁>0, or
K₂≦0 and K₁>0.

5. The optical arrangement according to claim 1, wherein the reflection diffraction grating consists of the unstructured layer on the light incidence side and the structured layer on the side that faces away from the light incidence side.

6. The optical arrangement according to claim 5, wherein the unstructured layer has a refractive index n₂ which satisfies the following conditions:
$$\vert \frac{{n}_{2}^{2} \sqrt{{n}_{in}^{2} - {n}_{in}^{2} sin α} - {n}_{in}^{2} \sqrt{{n}_{2}^{2} - {n}_{in}^{2} sin α}}{{n}_{2}^{2} \sqrt{{n}_{in}^{2} - {n}_{in}^{2} sin α} + {n}_{in}^{2} \sqrt{{n}_{2}^{2} - {n}_{in}^{2} sin α}} \vert < 0.05 and$$
$$\vert \frac{\sqrt{{n}_{in}^{2} - {n}_{in}^{2} sin α} - \sqrt{{n}_{2}^{2} - {n}_{in}^{2} sin α}}{\sqrt{{n}_{in}^{2} - {n}_{in}^{2} sin α} + \sqrt{{n}_{2}^{2} - {n}_{in}^{2} sin α}} \vert > 0.05 .$$

7. The optical arrangement according to claim 1, wherein the periodic structure of the structured layer has a grating profile which has not more than two levels.

8. The optical arrangement according to claim 7,
wherein the periodic structure of the structured layer has grating bars with a refractive index nₛ and grating trenches,
wherein the grating trenches contain air or a vacuum, and
wherein the grating bars and the unstructured layer are formed from the same material with a refractive index nₛ=n₂>nᵢₙ.

9. The optical arrangement according to claim 1, wherein the first medium is a prism, wherein the prism comprises a first surface, a second surface and a third surface, wherein the first surface of the prism is a light input surface of the optical arrangement, wherein the second surface of the prism is configured to reflect incident light to the third surface of the prism, wherein the reflection diffraction grating for the spectral decomposition of the incident light is arranged on the third surface of the prism, and wherein the second surface of the prism is a light output surface of the light that is reflected and spectrally decomposed by the reflection diffraction grating.

10. The optical arrangement according to claim 9, wherein the light is incident on the second surface at an angle (W) which is greater than a critical angle of total internal reflection.

11. The optical arrangement according to claim 9, wherein the angle of incidence (α) at which the light impinges on the third surface is greater than a critical angle of total internal reflection.

12. The optical arrangement according to claim 9, wherein an angle of incidence (γ) at which the light that is reflected by the reflection diffraction grating impinges on the second surface again is less than a critical angle of total internal reflection.

13. The optical arrangement according to claim 9, wherein grating bars of the reflection diffraction grating are coated with a material that has a refractive index n_{H} that is greater than the refractive index nᵢₙ of the prism.

14. The optical arrangement according to claim 9, wherein grating bars of the reflection diffraction grating have a refractive index nₛ that is greater than the refractive index nᵢₙ of the prism.

15. The optical arrangement according to claim 14, wherein the refractive index nₛ of the grating bars is nₛ>2.

16. The optical arrangement according to claim 9, wherein the prism has a refractive index nᵢₙ<1.6.
